(19) United States
(12) Patent Application Publication
(10) Pub. No.: US 2014/0352533 A1
(43) Pub. Date: Dec. 4, 2014

(54) SEEDED-GEL SYNTHESIS OF HIGH FLUX AND HIGH SELECTIVITY SAPO-34 MEMBRANES FOR CO2/CH4 SEPARATIONS

(71) Applicant: THE REGENTS OF THE UNIVERSITY OF COLORADO A BODY CORPORATE, Denver, CO (US)

(72) Inventors: John L. Falconer, Boulder, CO (US); Eric W. Ping, Broomfield, CO (US); Rongfei Zhou, Nanchang (CN); Richard D. Noble, Boulder, CO (US); Hans Funke, Boulder, CO (US)

(21) Appl. No.: 14/371,808

(22) PCT Filed: Jan. 10, 2013
(86) PCT No.: PCT/US13/21031

§ 371 Date: Jul. 11, 2014

Related U.S. Application Data
(60) Provisional application No. 61/585,521, filed on Jan. 11, 2012.

(51) Int. Cl. B01D 53/22; B01D 71/02; B05D 3/02; B01D 67/00

(52) U.S. Cl. CPC B01D 53/228; B01D 67/0051; B01D 71/028; B05D 3/0254; B01D 2053/221; B01D 2323/08; B01D 2323/40; B01D 2323/12
USPC 95/51; 96/11; 95/45; 427/244

(57) ABSTRACT

The invention provides methods for making silicoaluminophosphate-34 (SAPO-34) membranes comprising interlocking SAPO-34 crystals. In the methods of the invention, the SAPO-34 membranes are formed through in situ crystallization on a porous support using a synthesis mixture initially including a SAPO-34 forming gel and a plurality of SAPO-34 crystals dispersed in the gel. The invention also provides supported SAPO-34 membranes made by the methods of the invention. The invention also provides methods for separating a first gas component from a gas mixture, the methods comprising the step of providing a membrane of the invention.

### CROSS-REFERENCE TO RELATED APPLICATIONS

This application claims the benefit of U.S. Provisional Application No. 61/585,521, filed Jan. 11, 2012, which is hereby incorporated by reference in its entirety.

### BACKGROUND

Silicoaluminophosphates (SAPOs) are largely composed of Si, Al, P and O and can have a three-dimensional microporous crystal framework structure of PO₂⁺, AlO₂⁻ and SiO₂ tetrahedral units. The cages, channels and cavities created by the crystal framework can permit separation of mixtures of molecules based on their effective sizes and adsorption properties.

SAPO crystals can be synthesized by hydrothermal crystallization from a reaction mixture containing reactive sources of silica, alumina, and phosphate, and an organic templating agent. Lok et al. (U.S. Pat. No. 4,440,871) report gel compositions and procedures for forming several types of SAPO crystals, including SAPO-5, SAPO-11, SAPO-16, SAPO-17, SAPO-20, SAPO-31, SAPO-34, SAPO-35, SAPO-37, SAPO-40, SAPO 41, SAPO-42, and SAPO-44 crystals. Lok et al. do not appear to disclose formation of SAPO membranes. Prakash and Unnikrishnan report gel compositions and procedures for forming SAPO-34 crystals. (Prakash, A. M. and Unnikrishnan, S., J. Chem. Sc. Faraday Trans., 1994, 90(15), 2291-2296). In several of Prakash and Unnikrishnan's reported procedures, the gel was aged for 24 hours at 27° C. (300 K). Prakash and Unnikrishnan do not appear to disclose formation of SAPO-34 membranes.

SAPO membranes have been proposed for use in gas separations. For these applications, an important parameter is the separation selectivity. For two gas components i and j, a separation selectivity S_{i/j} greater than one implies that the membrane is selectively permeable to component i. If a feedstream containing both components is applied to one side of the membrane, the permeate stream exiting the other side of the membrane will be enriched in component i and depleted in component j. The greater the separation selectivity, the greater the enrichment of the permeate stream in component i.

Barri et al. report supported zeolite membranes (U.S. Pat. No. 5,567,664) and methods for the production of zeolite membranes on porous supports (U.S. Pat. No. 5,362,522). Barri et al. state that any type of zeolite-type material may be used, including silicoaluminophosphates.

SAPO-34 membranes on porous supports have been reported in the scientific literature. Lixiong et al. (Stud. Surf. Sci. Catl., 1997, 105, p 2211) reported synthesis of a SAPO-34 membrane on one side of a porous α-Al₂O₃ disk by immersing the substrate surface in a hydrogel and heating the substrate and gel. Lixiong et al. reported single gas permeances for H₂, N₂, CO₂, and n-C₄H₁₀. Poshuta et al. (Ind. Eng. Chem. Res., 1998, 37, 3924-3929; AlChE Journal, 2000, 46(4), 779-789) reported hydrothermal synthesis of SAPO-34 membranes on the inside surface of asymmetric, porous α-Al₂O₃ tubes. Poshuta et al. (supra) reported single gas and mixture permeances and ideal and mixture selectivities for several gases, including CO₂ and CH₄. The CO₂/CH₄ selectivities reported for a 50/50 CO₂/CH₄ mixture at 300K were between 14 and 36 for a feed pressure of 270 kPa and a pressure drop of 138 kPa (Poshusta et al., AlChE Journal, 2000, 46(4), pp 779-789). The CO₂/CH₄ selectivity was attributed to both competitive absorption (at lower temperatures) and differences in diffusivity. Li et al. reported an average CO₂/CH₄ selectivity of 76+/−19 for a 50/50 CO₂/CH₄ mixture at 295 K with a feed pressure of 222 kPa and a pressure drop of 138 kPa. The average CO₂ permeance was (2.3+/−0.2)×10⁻⁷ mol/(m²sPa) and the average CH₄ permeance was (3.1+/−0.8)×10⁻⁹ mol/(m²sPa). (Li, S. et al, Ind. Eng. Chem. Res. 2005, 44, 3220-3228. U.S. Patent Application Publication 2005/0204916-A1 to Li et al. reports CO₂/CH₄ separation selectivities of 67-93 for a 50/50 CO₂/CH₄ mixture at 297 K with a feed pressure of 222 kPa and a pressure drop of 138 kPa.

Several U.S. patents report processes for the manufacture of molecular sieve layers on a support which involve depositing or forming molecular sieve crystals on the support prior to an in situ synthesis step. U.S. Pat. No. 6,090,289 to Verduijn et al. reports a process which involves forming an intermediate layer by applying molecular sieve crystals to the support or forming such crystals on the support then contacting the resulting coated support with a molecular sieve synthesis mixture and subjecting the mixture to hydrothermal treatment in order to deposit an upper layer comprising a crystalline molecular sieve of crystals having at least one dimension greater than the dimensions of the crystals of the intermediate layer. U.S. Pat. No. 6,177,373 to Sterte et al. reports a process which involves depositing on a substrate a monolayer comprising molecular sieve monocrystals which are capable of nucleating the growth of a molecular sieve film, forming a molecular sieve synthesis solution, contacting the monolayer and the synthesis solution and hydrothermally growing molecular sieve to form a molecular sieve film on the substrate. U.S. Pat. No. 5,871,650 to Lai et al. reports a process for preparing a zeolite membrane exhibiting a columnar cross-sectional morphology.

As regards SAPO-34 membranes, U.S. Patent Application Publication 2007/0265484 A1 to Li et al reports SAPO-34 membranes fabricated via a technique in which SAPO-34 crystals are applied to the surface of a porous support prior to an in situ synthesis step. The publication reports CO₂/CH₄ selectivities of 94-115 for a 50/50 CO₂/CH₄ feed at 295 K with a 222 kPa pressure drop and a permeate pressure of 84 kPa. U.S. Patent Application Publication 2008/0216650 to Falconer et al. also relates to SAPO-34 membranes fabricated via a technique in which SAPO-34 crystals are applied to the surface of a porous support prior to in situ synthesis.

### BRIEF SUMMARY

In an embodiment, the invention provides methods for making silicoaluminophosphate-34 (SAPO-34) membranes comprising interlocking SAPO-34 crystals. In the methods of the invention, the SAPO-34 membranes are formed through in situ crystallization on a porous support using a synthesis mixture initially including a SAPO-34 forming gel and a plurality of SAPO-34 crystals dispersed in the gel. As compared to SAPO-34 membrane synthesis methods in which SAPO-34 “seed” crystals are applied to a surface of a porous support prior to in situ synthesis to form a membrane, the present membrane synthesis methods potentially reduce process cost, preparation time, and preparation complexity by eliminating the step of application of “seed” crystals to the surface of the support.

In an embodiment, the number and size of any pores in the SAPO-34 membranes which are not formed by the SAPO-34 crystal framework is sufficiently small that the membrane is selective for permeation of certain gases. For the SAPO-34 membranes of the invention, gases which are smaller than the framework pore size of SAPO-34 can have a higher permeance than gases which are larger than or about equal to the framework pore size (under the same permeation conditions). In an embodiment, the SAPO-34 membranes of the invention are selectively permeable to CO₂ over CH₄. The SAPO-34 membranes of the invention may be selectively permeable to CO₂ over CH₄ at pressure differentials in excess of 4 MPa. In an embodiment, the CO₂/CH₄ separation selectivity is greater than 50 and the CO₂ permeance is greater than 5×10⁻⁷ (mol/(m² s Pa)) for an approximately 50/50 CO₂/CH₄ mixture at about 295 K with a 153 kPa permeate pressure and pressure differential across the membrane of 4.6 MPa.

The size and concentration of the SAPO-34 crystals provided in the synthesis mixture is generally selected to produce a membrane with the desired selectivity and flux or permeance performance. Without wishing to be bound by any particular theory, it is believed that the selectivity of the SAPO-34 layer formed on the support may be undesirably low if the SAPO-34 crystal concentration is either too low or too high. Useful seed crystal concentrations may depend upon several factors including, but not limited to, the gel composition, the pH of the synthesis gel and the synthesis temperature. The methods of the invention are capable of producing membranes whose standard deviation in selectivity or permeance is less than or equal to 15% or 10%.

In an embodiment, the invention provides a method for making a crystalline silicoaluminophosphate-34 (SAPO-34) membrane, the method comprising the steps of:
a) providing a porous support;
b) preparing a SAPO-34 synthesis mixture comprising an aqueous SAPO-34 forming gel and a plurality of SAPO-34 crystals having an average size from 50 nm to 5000 nm, wherein the gel comprises aluminum, phosphorus, silicon, oxygen, and a templating agent, with the ratio of silicon to aluminum being greater than 0.1 and less than or equal to 0.6 and the overall concentration of SAPO-34 crystals in the gel is from 0.5 to 10 mg crystals per gram of gel;
c) contacting at least one surface of the porous support with the synthesis mixture, wherein the average pore size at the surface is less than 5 microns;
d) heating the porous support and the synthesis mixture to a temperature to form a continuous layer of SAPO-34 crystals on the surface of the support; and
e) heating the SAPO-34 layer to remove the templating agent.
   The average pore size of the support may be selected to be less than or equal to the average size of the SAPO-34 particles initially present in the synthesis gel. The average pore size of the support may be from 50 nm to less than 5 microns or from 50 nm to 1 micron. The composition of the SAPO-34 synthesis gel may be expressed in terms of the following molar ratios as: 1.0 Al₂O₃:aP₂O₅:bSiO₂:cR₁:dR₂:eH₂O, where R₁ and R₂ are templating agents. R₁ may be a quaternary ammonium templating agent, and the quaternary ammonium templating agent may be selected from the group consisting of tetrapropyl ammonium hydroxide (TPAOH), tetrapropyl ammonium bromide, tetrabutyl ammonium hydroxide, tetrabutyl ammonium bromide, tetraethyl ammonium hydroxide (TEAOH), tetraethyl ammonium bromide or combinations thereof. R₂ may be an amine having a molecular weight (Mn) of less than or equal to 300. The amine templating agent may be selected from dipropylamine (DPA), diethylamine (DEA), cyclohexylamine (CHA), triethylamine (TEA), phenethylamine (PEA), octylamine, morpholine, triethanolamine, diisopropylamine or combinations thereof. In an embodiment suitable for crystallization of SAPO-34 at 450K to 515 K for less than 20 hours a is 0.9-1.3, b is 0.3-0.6, c is 0.9-3.0, d is 1-2 and e is 120-190. In another embodiment, a is 0.9-1.3, b is 0.3-0.6, c is 0.9-3.0, d is 0 and e is 120-190 The synthesis gel may be aged for at least 6 hours, at least 24 hours, at least 48 hours, at least 72 hours, from 3 days to 7 days, from 6 hours to 72 hours, from 6 hours to 48 hours, from 6 hours to 24 hours, from 8 hours to 24 hours or from 8 hours to 12 hours at a temperature from 290 K to 350K prior to combination with the SAPO-34 crystals Alternately, the average size of the SAPO-34 crystals initially present in the synthesis gel (prior to step d) may be from 50 nm to 3,000 nm, from 50 nm to 1,000 nm, from 50 nm to 750 nm, from 50 nm to 500 nm, from 100 nm to 500 nm, from 150 nm to 450 nm, from 1,000 nm to 5,000 nm, 1,500 nm to 5,000 nm or 1,500 to 3,000 nm. In an embodiment, the SAPO-34 crystals added to the synthesis gel present a rectangular face with a plate-like morphology, with a face width 100 nm-4000 nm and a face length 100-4000 nm. The depth or thickness of the crystals may be less than the face width and length. For example, the thickness of the crystals may be from 30 to 3000 nm. The overall initial concentration of SAPO-34 crystals in the synthesis gel may also be from 1.0 mg to 8.0 mg crystals per gram of synthesis gel, 1.0 mg to 5.0 mg crystals per gram of synthesis gel, 2.0 mg to 4.0 mg crystals per gram of synthesis gel or 2.0 mg to 3.0 mg crystals per gram of synthesis gel. When the size of the SAPO-34 crystals in step b) is from 50 nm to 500 nm, the overall initial concentration of SAPO-34 crystals in the gel may be from 2.0 to 4.0 mg per gram of synthesis gel. Typically, the porous support is contacted with the synthesis gel prior to heating of the support and the synthesis gel to form the layer of SAPO-34 crystals. The layer of SAPO-34 crystals typically comprises interlocking crystals and forms a selective membrane. For example, the membranes may be selectively permeable to CO₂ over CH₄. The CO₂/CH₄ separation selectivity may be greater than 45 or 50 and the CO₂ permeance may be greater than 5×10⁻⁷ (mol/(m² s Pa)) for an approximately 50/50 CO₂/CH₄ mixture at about 295 K with a pressure differential across the membrane of about 4.6 MPa (for example a feed pressure of 4.75 MPa and 153 kPa permeate pressure; the feed flow rate may be 20 standard L/min). In some embodiments, the membrane may be formed after a single heating step d), while in other embodiments the heating step may be repeated to form the membrane. The porous support and the synthesis mixture may be heated to a temperature from 450K to 515K. In an embodiment, the porous support and the synthesis mixture are heated to a temperature from 450 K to 515K for less than 20 hours, less than 15 hours, 5-10 hours, 6-10 hours, or 6-8 hours. The SAPO-34 membrane synthesis methods of the invention may require additional synthesis time to obtain comparable selectivity when compared to methods in which SAPO-34 “seed” crystals are applied to the surface of the support prior to synthesis. For example, the synthesis time may be 1.25-1.75 times greater for the methods of the invention than for methods in which the SAPO-34 seed crystals are applied to the surface of the support prior to synthesis. Typically, the membrane is washed after step d) and prior to step e). The washing step may comprising washing in water for 15 minutes or more, for 2 hour to 3 days, for 2 hours to 2 days, for 2 hours to 1 day, for 2 hours to 8 hours, for 2 hours to 4 hours, for 4 hours to 2 days, for 4 hours to 1 day, or for 4 hours to 8 hours. The temperature of the washing liquid may be from 20° C. to 100° C., 20° C. to 75° C., 20° C. to 50° C., 25° C. to 100° C., 25° C. to 75° C., or 25° C. to 50° C. In different embodiments, the membrane layer may be heated at a temperature from 600 K to 1050 K in air, in an O₂ reduced atmosphere in an O₂ free atmosphere, or in vacuum. In different embodiments, the support is a single tube or a multichannel monolith.

In other aspects, the invention provides supported SAPO-34 membranes made by the methods of the invention. In an embodiment, the invention provides a SAPO-34 membrane supported on a multichannel monolith, the membrane being made by the methods of the invention. Typically, the surface of the monolith upon which the membrane is to be formed is porous. In an embodiment, the membrane is formed inside at least one channel of the monolith. In an embodiment, the channel diameter of the monolith may be from 3.0 to 10 mm. The SAPO-34 membrane supported on the monolith may have a thickness (above the support) from 1.5 to 5.0 microns or 2 to 4 microns.

The invention also provides methods for separating a first gas component from a gas mixture including at least a first and a second gas component. In an embodiment, the method comprises the steps of: a) providing a membrane of the invention, the membrane having a feed and a permeate side and being selectively permeable to the first gas component over the second gas component; b) applying a feed stream including the first and the second gas components to the feed side of the membrane; and c) providing a driving force sufficient for permeation of the first gas component through the membrane, thereby producing a permeate stream enriched in the first gas component from the permeate side of the membrane. In an embodiment, the first gas component is carbon dioxide and the second gas component is methane.

### BRIEF DESCRIPTION OF THE DRAWINGS

FIG. 1. SEM image of SAPO-34 seed crystals.

FIG. 2. SEM images of a SAPO-34 membrane made on a single channel support: a) surface of membrane; b) cross section of support and membrane

FIG. 3. Schematic of 7-channel alumina monolith support (Inopor GmbH).

FIG. 4. SEM images of a SAPO-34 monolith membrane: a) surface of inner channel; b) surface of outer channel; c) cross section of inner channel; d) cross section of outer channel

FIG. 5: CO₂ permeance and CO₂/CH₄ separation selectivity at 295 K versus feed pressure for a 7-channel SAPO-34 monolith membrane that was prepared using a seeded gel. The feed was 50/50 CO₂/CH₄ feed at 20 standard L/min.

### DETAILED DESCRIPTION

In an embodiment, the methods of the invention provide silicoaluminophosphate 34 (SAPO-34) membranes formed of interlocking SAPO crystals. SAPOs are zeolite-type molecular sieve materials, having a crystal structure of tetrahedra joined together through oxygen atoms to produce an extended network of channels of molecular dimensions. The SAPO crystals have a three-dimensional crystal framework structure of PO₂⁺, AlO₂⁻ and SiO₂ tetrahedral units, the framework structure defining a structure of regular cages, cavities, and channels. The dimensions of these channels and cavities are generally less than about 2 nanometers.

Crystalline SAPO-34 has the CHA structure and is an analog of the natural zeolite chabazite. The CHA framework structure contains single eight ring, double six ring, and single four ring secondary building units. The pore size is believed to be approximately 0.4 nm.

Other SAPOs have different structures and different pore sizes. SAPOs and other molecular sieves can be classified as small, medium, or large-pore molecular sieves based on the size of the largest oxygen rings in the structure. Crystalline SAPO-5 has the AFI structure which contains rings of 12 oxygen atoms, 6 oxygen atoms, and 4 oxygen atoms. SAPO-5 is typically considered a large-pore molecular sieve. In contrast, crystalline SAPO-11 has the AEL structure which contains rings of 10 oxygen atoms, 6 oxygen atoms, and 4 oxygen atoms. SAPO-11 is typically considered a medium-pore molecular sieve. Structures where the largest ring contains 8 or fewer oxygen atoms are typically considered small-pore molecular sieves. Further information regarding SAPO structures is available in Baerlocher, W. M. Meier and D. H. Olson, “Atlas of Zeolite Framework Types”, 5th ed., Elsevier: Amsterdam, 2001 and online at http://www.iza-strucures.org/databases.

In an embodiment, the silicoaluminophosphates formed by the methods of the invention have the framework composition (SiₓAl_{y}P_{z})O₂ where
x is between about 0.01 and about 0.98,
y is between about 0.01 and about 0.60, and
z is between about 0.01 and about 0.52.
   In another embodiment, monovalent Li; divalent Be, Mg, Co, Fe, Mn, and Zn; trivalent B, Ga, and Fe; tetravalent Ge and Ti; pentavalent As, or combinations thereof may be substituted into the SAPO framework structure.

Silicoaluminophosphates exhibit cation exchange properties. The excess negative charge in the lattice may be compensated by protons or by compensating cations located in the cavities of the structural framework. Acid hydrogen forms of SAPOs (e.g. H-SAPO-34) have protons that are loosely attached to their framework structure in lieu of inorganic compensating cations. Other forms of SAPO-34 include, but are not limited to Na-SAPO-34, Cu-SAPO-34, Li-SAPO-34, K-SAPO-34, Rb-SAPO-34, and Ca-SAPO-34. These may be made through ion-exchange of H-SAPO-34 or by including the appropriate cation in the synthesis gel.

The membranes of the invention are formed through in-situ crystallization of an aqueous silicoaluminophosphate-forming gel. The gel contains an organic templating agent. The term “templating agent” or “template” is a term of art and refers to a species added to the synthesis media to aid in and/or guide the polymerization and/or organization of the building blocks that form the crystal framework. Gels for forming SAPO crystals are known to the art, but preferred gel compositions for forming membranes may differ from preferred compositions for forming loose crystals or granules. The preferred gel composition may vary depending upon the desired crystallization temperature and time.

In an embodiment, the gel is prepared by mixing sources of aluminum, phosphorus, silicon, and oxygen in the presence of a templating agent and water. In an embodiment, the gel comprises Al, P, Si, 0, a templating agent and water. The composition of the mixture may be expressed in terms of the following molar ratios as: 1.0 Al₂O₃:aP₂O₅:bSiO₂:dR₂:eH₂O, where R₁ and R₂ are templating agents. In an embodiment, R₁ is a quaternary ammonium templating agent, and the quaternary ammonium templating agent is selected from the group consisting of tetrapropyl ammonium hydroxide (TPAOH), tetrapropyl ammonium bromide, tetrabutyl ammonium hydroxide, tetrabutyl ammonium bromide, tetraethyl ammonium hydroxide (TEAOH), tetraethyl ammonium bromide or combinations thereof. R₂ is an amine having a molecular weight (Mn) of less than or equal to 300, and the amine templating agent is selected from dipropylamine (DPA), diethylamine (DEA), cyclohexylamine (CHA), triethylamine (TEA), phenethylamine (PEA), octylamine, morpholine, triethanolamine, diisopropylamine or combinations thereof. In an embodiment, suitable for crystallization between about 420 K and about 540 K, a is between about 0.01 and about 52, b is between about 0.03 and about 196, c is between about 0.2 and about 5, d is between 0 to about 4 and e is between about 20 and about 300. If other elements are to be substituted into the structural framework of the SAPO, the gel composition can also include Li₂O, BeO, MgO, CoO, FeO, MnO, ZnO, B₂O₃, Ga₂O₃, Fe₂O₃, GeO, TiO, As₂O₅ or combinations thereof. If compensating cations are to be included in the cavities of the structural framework, the gel composition can also include sources of the compensating cations (for example, NaOH for Na⁺, LiOH for Li⁺, KOH for K⁺, RbOH for Rb⁺, and CsOH for Cs⁺).

In an embodiment suitable for crystallization of SAPO-34, c is less than about 2. In an embodiment suitable for crystallization of SAPO-34 membranes at 453K to 533K or 450K to 515K for 20-24 hours, a is about 1 (e.g. 0.9-1.1), b is 0.3-0.6, c is 1.07-1.2, d is 0 and e is 55-56. In an embodiment suitable for crystallization of SAPO-34 membranes at 453K to 533 K or 450 to 515K for less than 20 hours a is about 1 (e.g. 0.9-1.1), b is 0.3-0.6, c is 0.9-1.2 d is 1-2 and e is 120-180. In an embodiment suitable for crystallization of SAPO-34 seed particles at 453K to 533 K or 450 to 515K for less than 20 hours, a is 0.9-1.1, b is 0.3-0.6, c is 0.9-1.2, d is 0 and e is 45-65.

One important gel composition parameter is the ratio of Si to Al. In an embodiment, the ratio of Si to Al is high enough so that AlPO₅ is not formed. In different embodiments, the ratio of silicon to aluminum is greater than 0.1, greater than 0.10 and less than or equal to 0.6, between 0.10 and 0.6, between 0.15 and 0.45, from 0.15 to 0.3, between 0.15 and 0.3, from 0.15 to 0.2, or is about 0.15.

In an embodiment, the gel is prepared by mixing sources of phosphate and alumina with water for several hours. The mixture is then stirred before adding the source of silica. The mixture may be stirred before adding the template. In an embodiment, the source of phosphate is phosphoric acid. Suitable phosphate sources also include organic phosphates such as triethyl phosphate, and crystalline or amorphous aluminophosphates. In an embodiment, the source of alumina is an aluminum alkoxide, such as aluminum isopropoxide or an aluminum hydroxide or a combinations thereof. Suitable alumina sources also include pseudoboehmite and crystalline or amorphous aluminophosphates (gibbsite, sodium aluminate, aluminum trichloride). In an embodiment, the source of silica is a silica sol. Suitable silica sources also include fumed silica, reactive solid amorphous precipitated silica, silica gel, alkoxides of silicon (silicic acid or alkali metal silicate).

In different embodiments, the initial pH of the synthesis gel may be from 7.5 to 11, from 7.5 to 8, or from 8.5 to 11.

In an embodiment, the gel is aged prior to use. As used herein, an “aged” gel is a gel that is held (not used) for a specific period of time after all the components of the gel are mixed together or a gel that is maintained at a temperature below the membrane synthesis temperature for a specific period of time after all the components are mixed. In an embodiment, the gel is sealed and stirred during storage to prevent settling and the formation of a solid cake. Without wishing to be bound by any particular theory, it is believed that aging of the gel affects subsequent crystallization of the gel by generating nucleation sites. In general, it is believed that longer aging times lead to formation of more nucleation sites. The preferred aging time will depend upon the aging temperature selected. Preferably, crystal precipitation is not observed during the aging period. In an embodiment, the viscosity of the aged gel is such that the gel is capable of penetrating the pores of the porous support. After initial mixing of the components of the synthesis gel in a container, material can settle to the bottom of the container. In an embodiment, the gel is stirred and aged until no settled material is visible at the bottom of the container and the gel appears translucent and substantially uniform to the eye. In different embodiments, the aging time is greater than ten hours, or greater than twenty four hours. In different embodiments, the aging time at room temperature is at least about twenty-four hours, greater than about twenty-four hours, at least about forty-eight hours, and at least about seventy-two hours. For SAPO-34 membranes, in different embodiments the aging time at room temperature or above can be at least twenty four hours, greater than about twenty-four hours, at least about forty-eight hours, at least about seventy-two hours, between about three days and about seven days or between four days and 28 days. In an embodiment, the gel is not aged longer than one month. In different embodiments, the aging temperature is between 283 K and 348 K or between 298 K and 333 K. In different embodiments, the aging time is at least 24 hours between 290 K and 350K, between 290K and 335K, or between 290 K and 300 K. Aging of the gel may take place before the gel and the support are placed in contact. If more than one crystallization step is used, the same batch of gel may be used for all the crystallization steps, so long as the upper limit of the aging time is not exceeded. Alternately, more than one batch of gel may be prepared and aged, with different batches being used for one or more crystallization step(s). In an embodiment, each crystallization step may use a different batch of gel. The aging time of different batches of gel at the time of use may be the same or may be different. In another embodiment, aging of the gel is not required to obtain the desired quality of membrane.

In different embodiments, the average size of the SAPO-34 crystals initially present in the synthesis mixture is between 25 nm and 5 micrometers, from 50 nm to 5,000 nm, from 50 nm to 3,000 nm, from 50 nm to 1,000 nm, from 50 nm to 750 nm, from 50 nm to 500 nm, from 100 nm to 500 nm, from 150 nm to 450 nm, from 1,000 nm to 5000 nm, 1,500 nm to 5000 nm or 1,500 to 3,000 nm. In an embodiment, the SAPO-34 crystals are formed via a microwave synthesis technique. In an embodiment, the average size of the SAPO-34 crystals provided in the synthesis gel is larger than the average pore size at the surface of the support. The size of the crystals may be selected to allow some dissolution of the crystals in the SAPO-34 forming gel. In an embodiment, the SAPO-34 crystals are not calcined before being added to the synthesis mixture.

In an embodiment, the SAPO-34 crystals to be incorporated into the synthesis mixture are first incorporated in a suspension, such as an aqueous suspension. This suspension of SAPO-34 crystals may then be incorporated into the synthesis mixture.

In an embodiment, the concentration of the SAPO-34 crystals initially present in the synthesis mixture is from 0.5 to 10 mg crystals per gram of synthesis gel (SAPO-34 forming gel), 1.0 mg to 8.0 mg crystals per gram of synthesis gel, 1.0 mg to 5.0 mg crystals per gram of synthesis gel, 2.0 mg to 4.0 mg crystals per gram of synthesis gel or 2.0 mg to 3.0 mg crystals per gram of synthesis gel.

The synthesis mixture containing the gel is brought into contact with at least one surface of the porous support. In an embodiment, the porous support has two sides (e.g. the inside and outside of a tube or the top or bottom of a plate or disk) and the gel is brought into contact with only one side of the support. One side of the support may be masked to limit its contact with the gel. Suitable masking techniques are known to the art. One known masking technique involves covering the surface with a polymer layer, for example covering it with fluoropolymer tape or a shrinkwrap tube. Another masking technique involves infiltrating the pores of the support with an organic masking agent, such as a polymer or a wax, which can later be removed through thermal treatment. In another embodiment, the porous support may be immersed in the gel so that more than one surface of the porous support contacts the gel. In an embodiment, at least some of the gel penetrates the pores of the support. The pores of the support need not be completely filled with gel. In an embodiment, the porous support is brought into contact with a sufficient quantity of gel such that growth of the SAPO membrane is not substantially limited by the amount of gel available.

The porous support is a body capable of supporting the SAPO membrane. The porous support may be of any suitable shape, including disks, tubes or a shape incorporating multiple channels. In an embodiment, the porous support is in the form of a tube or multichannel support or monolith. In an embodiment, the porous support is a metal or an inorganic material. In an embodiment, the porous support does not appreciably dissolve or form reaction products at the interface when placed in contact with the synthesis gel. Suitable inorganic porous supports include, but are not limited to, α-alumina, glass, titania, zirconia, carbon, silicon carbide, clays or silicate minerals, aerogels, supported aerogels, and supported silica, titania and zirconia. Suitable porous metal supports include, but are not limited to, stainless steel, nickel based alloys (Inconel, Hastalloy), Fecralloy, chromium and titanium. The metal may be in the form of a fibrous mesh (woven or non-woven), a combination of fibrous metal with sintered metal particles, and sintered metal particles. In an embodiment, the metal support is formed of sintered metal particles.

The average pore size of the support may be selected in view of the average size of the SAPO-34 crystals initially present in the synthesis mixture and/or the average size of the SAPO-34 crystals formed during in-situ crystaliization. Often, a porous support will have a distribution of pore sizes. In an embodiment, the pore size of the support is relatively uniform throughout the support. In this case, the pore size at the surface of the support can be characterized by the pore size of the support as a whole. In an embodiment, the pore size characteristic of the surface of the support may be taken as the pore size characteristic of the support as a whole. In another embodiment, the support may have a different pore size at or near the surface on which the membrane is to be formed than the pore size away from the surface. For example, the support may have two well-defined regions, a first layer with a smaller average pore size (on which the membrane is to be formed) and a second layer with a larger average pore size. When the support has regions or layers which differ in pore size, the pore size at the surface can be characterized by pore size of the region or layer nearest the surface on which the membrane is to be formed. In an embodiment, the pore size characteristic of the surface of the support may be taken as the pore size characteristic of the surface layer or region of the support.

Preferably, the average pore diameter of at the surface of the support is greater than about 0.05 microns or greater than about 0.1 microns. The pore diameter of the support being greater than about 0.1 microns does not require that every single pore in the support is greater than about 0.1 microns, but it does exclude supports having regions where the characteristic pore size is about 0.1 microns (for example, a support having a layer with an 0.1 micron average pore size). In different embodiments, the average pore size of the support is greater than or equal to about 50 nm, from 50 nm to 6 microns, from 50 nm to 5 microns, from 50 nm to 1 micron, from 100 nm to 6 microns, between about 0.1 microns and about 6 microns, from 100 nm to 1 micron, between about 0.2 and about 6 microns, between about 0.5 and about 6 microns, between about 1 micron and about 6 microns, between about 2 and about 6 microns, about 4 microns, or less than 5 microns. The average or characteristic pore size of the support may be assessed by several methods including microscopy techniques and mercury porosimetry. The porous support may be joined to nonporous material which provides a sealing surface for use of the membrane. This nonporous material may also be immersed in or partially covered with synthesis gel during the synthesis process, in which case SAPO crystals may form on the nonporous material as well.

In an embodiment, the porous support is cleaned prior to being brought into contact with the synthesis gel. The support may be cleaned by being boiled in purified water. After cleaning with water, the support may then be dried.

After the porous support and the synthesis mixture are brought into contact, the support and the synthesis mixture are heated in a SAPO-34 crystal synthesis step. This synthesis step can lead to formation of SAPO-34 crystalline material on and in the porous support. As used herein, crystalline material includes both newly formed crystals and crystalline material grown on previously formed crystals. During each synthesis step a layer of SAPO crystals can be said to form on the surface of the porous support and/or on previously formed SAPO crystals. The layer of SAPO crystals formed during each synthesis step may not be continuous. During the synthesis step, crystals may also precipitate from the synthesis gel without being incorporated into the SAPO membrane. In an embodiment, the synthesis temperature is between about 420 K and about 540 K. In different embodiments, the synthesis temperature is between about 453 K and about 553 K, from 453 K to 530 K, from 470 K to 490 K, from 480 K to 490 K, 453 K to 515 K or between about 470 K and about 515 K to form a continuous layer of SAPO-34 crystals on the surface of the support. In different embodiments, the crystallization time is from 5 to 10 hours, 6 to 10 hours, 6 to 8 hours, from 15 to 25 hours, from 20-25 hours, less than 20 hours or less than 15 hours. Synthesis typically occurs under autogenous pressure. During the synthesis step, the synthesis mixture may be essentially stationary with respect to the support or may move relative to the support. For example, the synthesis mixture may be flowed through channels in the support.

In an embodiment, excess synthesis mixture is removed from the support and the SAPO crystals after each synthesis step. The excess synthesis mixture may be removed by washing with water. The washing step may comprising washing in water for 15 minutes or more, for 2 hour to 3 days, for 2 hours to 2 days, for 2 hours to 1 day, for 2 hours to 8 hours, for 2 hours to 4 hours, for 4 hours to 2 days, for 4 hours to 1 day, or for 4 hours to 8 hours. In addition, the washing step may comprise a rinsing step, a soaking step, or a combination thereof. The rinsing step may be in tap water or deionized water while the soaking step may be in deionized water. The soaking step may be 2 hour to 3 days, for 2 hours to 2 days, for 2 hours to 1 day, for 2 hours to 8 hours, for 2 hours to 4 hours, for 4 hours to 2 days, for 4 hours to 1 day, or for 4 hours to 8 hours in duration. The water in which the membrane is soaked may be exchanged at least one time during the soaking step. After washing with water, the support and SAPO crystals may then be dried.

In an embodiment, the synthesis step may be repeated in order to form a greater amount of SAPO crystals. After each synthesis step, the excess synthesis mixture is removed and then the porous support is brought into contact with synthesis mixture before performing the next synthesis step. Sufficient synthesis steps are performed so that the cumulative layer formed on the support surface by the synthesis steps forms a continuous layer. The SAPO-34 membrane is formed by the cumulative layer(s) of SAPO crystals on the support surface(s) and the (interconnected) SAPO crystals formed inside the porous support (if present). In an embodiment, the SAPO crystals inside the support are substantially interconnected. In an embodiment, the interconnected SAPO crystals are connected to the layers of SAPO crystals formed on the support surface. In an embodiment, sufficient synthesis steps are performed that the membrane is impermeable to nitrogen after preparation (but before calcination).

After SAPO-34 crystal synthesis is complete, the SAPO-34 membranes are heated to substantially remove the organic template material. After template removal, the membrane becomes a semi-permeable barrier between two phases that is capable of restricting the movement of molecules across it in a very specific manner.

In one embodiment, the SAPO-34 membrane layer is heated at a temperature from 600 K to 1050 K in an O₂ reduced atmosphere or an O₂ free atmosphere thereby removing the templating agent from the membrane layer. In a further embodiment, the membrane layer is heated at a temperature from about 625 K to about 775 K to remove the templating agent. In a further embodiments, the membrane layer is heated at a temperature from about 650 K to about 700 K, from about 650 K to about 675 K, from 670 to 700 K, or from 700K to 750 Kto remove the templating agent.

In a further embodiment, the template removal step is performed by heating the membrane layer from 2.5 hours to 24 hours at the desired temperature. In another embodiment, the template removal step is performed by heating the membrane layer from 2.5 hours to 15 hours at the desired temperature. In another embodiment, the template removal step is performed by heating the membrane layer from 3 hours to 10 hours at the desired temperature. In another embodiment, the template removal step is performed by heating the membrane layer from 3.5 hours to 4.5 hours at the desired temperature.

In one embodiment, the template removal step is performed by heating the membrane for 3 hours to 10 hours at a temperature from about 650 K to about 700 K, from 670 K to 725 K, or from 725K to 775 K. In a further embodiment, the template removal step is performed by heating the membrane for 3.5 hours to 4.5 hours at a temperature from about 650 K to about 675 K.

By “O₂ reduced atmosphere”, it is meant that the templating agent is removed from the membrane layer in a gas atmosphere containing less than 10% O₂ by volume, preferably less than 5% O₂, more preferably less than 3% O₂, more preferably less than 2% O₂, more preferably less than 1% O₂, more preferably less than 0.1% O₂, even more preferably less than 0.01% O₂. By “O₂ free atmosphere”, it is meant that the template is removed in a gas atmosphere containing no significant amounts of O₂ (such as less than 0.001%). In some embodiments, the templating agent is removed by heating the membrane layer under a vacuum, including but not limited to low vacuums (100 kPa to 3 kPa), medium vacuums (3 kPa to 100 mPa) and high vacuums (100 mPa to 100 nPa). In one embodiment, the templating agent is removed by heating the membrane layer under a low vacuum or medium vacuum. In another embodiment the templating agent is removed by heating the membrane layer under an inert gas. As used herein, an “inert gas” is any gas which is chemically non-reactive under the template removal conditions provided herein, and which can include but is not limited to nitrogen, argon, helium, neon, krypton, xenon and combinations thereof. In one embodiment, the templating agent is removed by heating the membrane layer under an inert gas selected from the group consisting of nitrogen, argon, helium and combinations thereof. As used herein, “air” refers to the general gas composition of Earth's atmosphere. Dry air contains roughly (by volume) 78% nitrogen, 21% oxygen, 0.93% argon, 0.038% carbon dioxide, and small amounts of other gases.

As a result of heating the membrane layer, 90% or more of the templating agent and its decomposition products is removed from the membrane, preferably 95% or more, preferably 99% or more, or even more preferably all of the templating agent and its decomposition products is removed from the membrane. In one embodiment, heating the membrane layer does not form any oxidized derivatives from the templating agent. In a further embodiment, no additional calcination steps are performed to remove the templating agent or any oxidized derivatives thereof, which includes any subsequent calcination steps performed in the presence of O₂. In some embodiments, the membrane gel comprises two or more templating agents, wherein the template removal step removes each of the templating agents.

In another embodiment, the organic templating agent may be removed from the SAPO-34 membrane by heating the membrane in stagnant air (calcination). In different embodiments, the calcination temperature is between about 600 K and about 900K, and between about 623 K and about 773 K. For membranes made using TEAOH and DPA as templating agents, the calcining temperature can be between about 623 K and about 773 K. In an embodiment, the calcination time is between about 5 hours and about 25 hours. Longer times may be required at lower temperatures in order to substantially remove the template material. Use of lower calcining temperatures can reduce the formation of calcining-related defects in the membrane. The heating rate during calcination should be slow enough to limit formation of defects such as cracks. In an embodiment, the heating rate is less than about 2.0 K/min. In a different embodiment, the heating rate is about 1.0 K/min. Similarly, the cooling rate must be sufficiently slow to limit membrane defect formation. In an embodiment, the cooling rate is less than about 2.0 K/min. In a different embodiment, the cooling rate is about 1.0 K/min.

In an embodiment, the SAPO-34 membranes of the present invention comprise SAPO-34 crystals which form a continuous layer on at least one side of the porous support. SAPO-34 crystals may also be present within at least some of the pores of the support. The thickness of the SAPO-34 layer depends in part on the number of synthesis steps performed. In embodiment where synthesis steps are performed until the membrane is impermeable to nitrogen, the thickness of the cumulative SAPO layer is less than about 20 microns. When the layer thicknesses are measured from cross-sections with scanning electron microscopy, the uncertainty in the thickness measurement is believed to be on the order of +/−10%. In other embodiments, the thickness of the SAPO layer is about 5 microns, less than 5 microns, from 2-3 microns or about 2.5 microns. The membrane comprises interlocking SAPO-crystals. In different embodiments, at least some of the SAPO-crystals may present a rectangular face of width of at least 100 nm and height of at least 100 nm, or of width 100 nm-4,000 nm and height 100 to 4,000 nm.

Transport of gases through a zeolite-type membrane can be described by several parameters. As used herein, the flux, Jᵢ, through a membrane is the number of moles of a specified component i passing per unit time through a unit of membrane surface area normal to the thickness direction. The permeance or pressure normalized flux, Pᵢ, is the flux of component i per unit transmembrane driving force. For a diffusion process, the transmembrane driving force is the gradient in chemical potential for the component (Kärger, J. Ruthven, D. M., Diffusion in Zeolites, John Wiley and Sons: New York, 1992, pp. 9-10). The selectivity of a membrane for components i over j, S_{i/j} is the permeance of component i divided by the permeance of component j. The ideal selectivity is the ratio of the permeances obtained from single gas permeation experiments. The actual selectivity (also called separation selectivity) for a gas mixture may differ from the ideal selectivity.

Transport of gases through zeolite pores can be influenced by several factors. As used herein, “zeolite pores” are pores formed by the crystal framework of a zeolite-type material. A model proposed by Keizer et al. (J. Memb. Sci., 1998, 147, p. 159) has previously been applied to SAPO-34 membranes (Poshusta et al., AlChE Journal, 2000, 46(4), pp 779-789). This model states that both molecular sizes relative to the zeolite pore and the relative adsorption strengths determine the faster permeating species in a binary mixture. This gives rise to three separation regimes where both components are able to diffuse through the molecular sieve pores. In the first region, both molecules have similar adsorption strengths, but one is larger and its diffusion is restricted due to pore walls. In the first region, the membrane is selective for the smaller molecule. In region 2, both molecules have similar kinetic diameters, but one adsorbs more strongly. In region 2, the membrane is selective for the strongly adsorbing molecule. In region 3, the molecules have significantly different diameters and adsorption strengths. The effects of each mechanism may combine to enhance separation or compete to reduce the selectivity.

Transport of gases through a crystalline zeolite-type material such as a SAPO membrane can also be influenced by any “nonzeolite pores” in the membrane structure. “Nonzeolite pores” are pores not formed by the crystal framework. Intercrystalline pores are an example of nonzeolite pores. The contribution of nonzeolite pores to the flux of gas through a zeolite-type membrane depends on the number, size and selectivity of these pores. If the nonzeolite pores are sufficiently large, transport through the membrane can occur through Knudsen diffusion or viscous flow. For some SAPO-34 membranes, membranes with more nonzeolite pores have been shown to have lower CO₂/CH₄ selectivities (Poshusta et al., AlChE Journal, 2000, 46(4), pp 779-789). As the pressure drop increases, any transport through viscous flow contributes more to the overall flux and thus can decrease the selectivity of the membrane. Therefore, membranes with fewer nonzeolite pores can have better separation selectivities at higher pressures.

The membranes of the invention can be selectively permeable to some gases over others. For example, the SAPO-34 membranes of the invention are selectively permeable to CO₂ over CH₄, especially at lower temperatures. Therefore, the invention provides a method for separating two gases in a feed stream including these two gas components using the membranes of the invention. The feed stream is applied to the feed side of the membrane, generating a retentate stream and a permeate stream. In order to separate the two gases, sufficient trans-membrane driving force must be applied that at least one of the gases permeates the membrane. In an embodiment, both gases permeate the membrane. If the membrane is selectively permeable to a first gas component over a second gas component, the permeate stream will be enriched in the first gas component while the retentate stream will be depleted in the first component. The permeate stream being enriched in the first gas component implies that the concentration of the first gas component in the permeate stream is greater than its concentration in the feed stream. Similarly, the retentate stream being depleted in the first gas component implies that the concentration of the first gas component in the retentate stream is less than its concentration in the feed stream.

The SAPO-34 membranes of the invention may have room-temperature CO₂/CH₄ separation selectivities greater than about 50 and CO₂ permeance greater than 5×10⁻⁷ (mol/(m²s Pa)) for an approximately 50/50 CO₂/CH₄ mixture at about 295 K with a 153 kPa permeate pressure and pressure differential across the membrane of 4.6 MPa. Alternately, the CO₂/CH₄ separation selectivity may be greater than 45 or 50 and the CO₂ permeance may be greater than 5×10⁻⁷ (mol/(m² s Pa)) for an approximately 50/50 CO₂/CH₄ mixture at about 295 K with a pressure differential across the membrane of about 4.6 MPa (for example a feed pressure of 4.75 MPa and 153 kPa permeate pressure; the feed flow rate may be 20 standard L/min).

All references cited herein are incorporated by reference to the extent not inconsistent with the disclosure herein.

When a Markush group or other grouping is used herein, all individual members of the group and all combinations and subcombinations possible of the group are intended to be individually included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

In general the terms and phrases used herein have their art-recognized meaning, which can be found by reference to standard texts, journal references and contexts known to those skilled in the art. The preceding definitions are provided to clarify their specific use in the context of the invention.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Those of ordinary skill in the art will appreciate that the SAPO membranes of the invention may be made using starting materials other than those specifically disclosed herein and that procedures and techniques functionally equivalent to those described herein can be employed to make, assess, and use the SAPO membranes described herein.

### Example 1

Abstract: SAPO-34 zeolite membrane synthesis was scaled up by preparing membranes on seven-channel monolith alumina supports. The membranes prepared on these monoliths had CO₂ permeances and CO₂/CH₄ separations selectivities at 4.6 MPa pressure differential that were similar to SAPO-34 membranes on single channel supports. They also exhibited similar pressure dependence. SAPO-34 membrane preparation was modified by adding SAPO-34 seed crystals to the synthesis gel instead of placing seeds on the support surface. Membranes prepared by seeded-gel synthesis generally had higher CO₂ permeances, higher CO₂/CH₄ separation selectivities, and smaller standard deviations for these values than membranes prepared by rub-coating or dip coating seeding methods. Using seeded-gel synthesis also decreased the number of synthesis steps, but increased the amount of seeds needed by two orders of magnitude.

Introduction: The separation of carbon dioxide from methane is important for processing natural gas streams contaminated with large quantities of CO₂, which decreases the energy content of the gas and is corrosive in the presence of moisture. Polymeric membranes selective to CO₂ were installed in the 1980s (1), but because natural gas wells are at high pressures, CO₂/CH₄ mixtures must be separated at high pressures, which can plasticize polymeric membranes and decrease their separation performance (2).

It was previously reported that SAPO-34 zeolite membranes have high CO₂/CH₄ separation selectivities and fluxes, and have superior thermal, mechanical and chemical stability at high CO₂ pressures (3-11). Their overall separation performance decreases as the pressure increases because Knudsen and viscous flow through membrane defects contribute proportionally more to the CH₄ flux as the pressure increases. In addition, at high pressures the CO₂ concentration near the membrane surface becomes lower than the bulk CO₂ concentration because as the feed pressure increases, the velocity through the membrane and the bulk diffusivity decrease. Also, the CO₂ flux increases so that a larger fraction of the CO₂ feed permeates for the same feed rate (4). All three of these factors contribute to concentration polarization, which decreases both permeance and selectivity. Inserts in the membranes tubes were used to minimized concentration polarization by decreasing the void volume and therefore increasing the linear velocity. The inserts also decreased the diffusion distance from the bulk to the membrane surface. Using inserts and high feed flow rates allows better approximations to the intrinsic membrane properties to be obtained.

Ideally, defect-free SAPO-34 membranes should have high CO₂/CH₄ selectivities because the smaller CO₂ molecule (0.33 nm) diffuses faster than CH₄ (0.38 nm) and because CO₂ preferentially adsorbs in the SAPO-34 pores (0.38-nm diameter). Li, et al. showed that 6-cm long SAPO-34 tubular membranes had high CO₂/CH₄ separation selectivities at pressures up to 7 MPa (8). Li, et al. also scaled SAPO-34 tubular membranes up to 25-cm lengths (3).

In the current study, SAPO-34 membranes were synthesized on alumina monolith supports, which were 6-cm long, had a 2.5-cm OD, and contained seven 6-mm ID channels. These monoliths have six times the surface area per unit length of the tubular membranes. The objective was to determine if the same preparation procedure could be used for scale-up to monoliths, and to obtain high fluxes and selectivities for CO₂/CH₄ separations at high pressures since the larger surface area per volume makes monoliths attractive for large scale applications.

Previously, Kalipcilar et al. reported that ZSM-5 membranes could be synthesized without seeding on multi-channel monolith supports for low pressure gas separations and for separating alcohol-water mixtures by pervaporation (12-14). The monolith supports had 66 square channels (2-mm ID) and thus provided a high membrane surface area per volume ratio while maintaining the chemical and structural stability of the tubular membranes. These applications were not as demanding as high pressure separations of CO₂/CH₄ mixtures where few defects can dramatically decrease selectivity.

In this work, large-diameter channels were used for monolith scale up for high-pressure separations since selective SAPO-34 membranes have only been prepared by seeding the support surface with SAPO-34 seed crystals. Thus, the second aspect of the current study was to develop a preparation method that did not require the support surface to be seeded with SAPO-34 crystals. This was accomplished by adding SAPO-34 seeds directly to aged synthesis gel just before the gel was added to the support and placed in the autoclave. Selective membranes were prepared by this method after determining the an acceptable seed concentration and increasing the synthesis time. This approach reduces the number of steps in the SAPO-34 membrane preparation and thus decreases the preparation time. Additionally, the removal of a manual seeding step simplifies the preparation of membranes with smaller channels that are less accessible for seeding by hand. Using seeded gels instead of placing seeds directly on the support surface may also be effective for preparing other types of zeolite membranes.

Scale up to monolith supports introduces a number of changes that may affect the preparation of high-quality SAPO-34 membranes. Because temperature gradients across the support may be larger during synthesis, the membrane layer in the channels may be less uniform. For example, the time that the center channel is at synthesis temperature could be too short to form a continuous SAPO-34 layer in that channel, which would mean the entire membrane would have low selectivity. The ratio of synthesis gel volume to support surface area in a channel is also lower for a monolith. As a result, the gel composition may change more during synthesis and thus the final membrane properties may change if the gel does not circulate much within the channel. Also, a larger total mass of template must be removed after synthesis to open the SAPO-34 pores, and permeances would be lower if template remains in the membrane (15).

In addition to the possible changes expected during membrane synthesis in monoliths, separating CO₂/CH₄ mixtures at high pressures in monoliths may also be different. The gases diffuse a longer distance through the monolith support after permeating the zeolite layer, and this could reduce the driving force across the membrane layer. Because the total surface area is six times larger than in the tubular membranes, the total flux is expected to be approximately six times larger, and maintaining high velocities near the membrane surface is more difficult because the upper limit of the feed flow rate for the separations system is reached. As a result, concentration polarization becomes more significant, particularly closer to the exit of the retentate from the membrane. Avila, et al found that concentration polarization in some tubular membranes decreased both CO₂ permeance and CO₂/CH₄ selectivity by more than 50% (4). In addition, measurements are carried out at a higher stage cut where the CO₂ feed concentration near the membrane exit is lower, and thus the driving force for permeation is lower. Moreover, the larger permeate gas flow rate (up to 8 L/min STP) may cause a larger pressure drop between the permeate side of the membrane and the system exhaust, and a higher permeate pressure decreases membrane flux.

It is shown herein that SAPO-34 membranes with high selectivities and permeances for CO₂/CH₄ separation at 4.6 MPa pressure differential can be reproducibly synthesized on seven-channel alumina monolith supports. Because the monoliths geometry differs from tubular supports, and they have a higher surface area to volume ratio and larger thermal mass, some synthesis parameters were modified to obtain high-quality membranes. It is also shown that using a seeded gel yielded membranes that had better separation performance than those that were prepared by placing seeds on the support surfaces.

### Experimental Method

### Microwave Synthesis of SAPO-34 Seeds

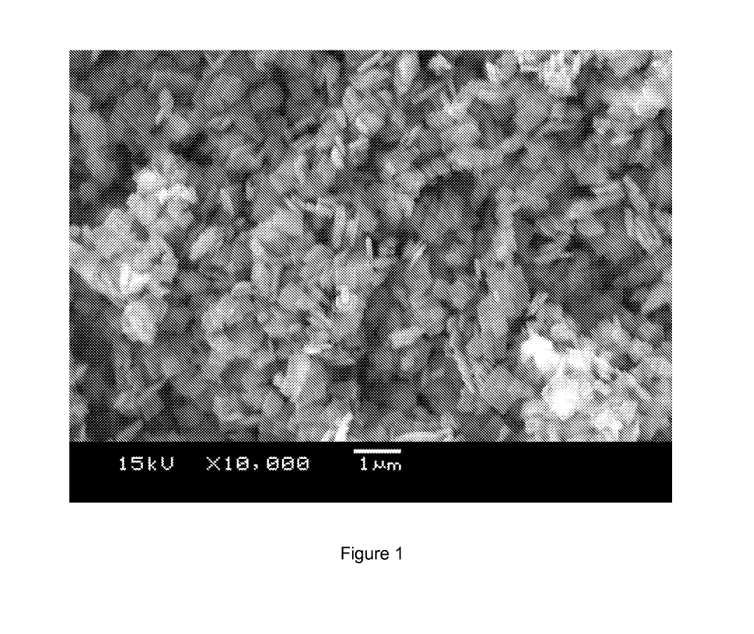

SAPO-34 seeds were synthesized with a gel molar ratio of 1.0 Al₂O₃:2.0 P₂O₅:0.6 SiO₂:4.0 tetraethyl ammonium hydroxide (TEAOH): 75 H₂O. In a typical synthesis, Al(i-C₃H₇O)₃ (98%, Sigma-Aldrich), TEAOH (35 wt % aqueous solution, Sigma-Aldrich), and deionized water were stirred for 2 h to form a homogeneous solution. Ludox AS-40 colloidal silica (40 wt % aqueous suspension, Sigma-Aldrich) was added and the resulting solution stirred for 2 h. Then H₃PO₄ (85 wt % aqueous solution, Sigma-Aldrich) was added, and the solution was stirred for 3 days at room temperature. The final gel was transferred to an autoclave and heated in a microwave oven (OEM Mars Microwave Reaction System with XP-1500 plus reactor) to 453 K for 7 h. After the reaction mixture cooled below 343 K, the seeds were centrifuged at 7000 rpm for 30 min and washed with DI water. The centrifuging and washing was repeated three times and the resulting SAPO-34 seeds were dried overnight in an oven at 323 K. A SEM photo of some seed crystals is shown in FIG. 1; at least some of the SAPO-crystals presented a rectangular face of width of at least 100 nm and height of at least 100 nm; the thickness of some of the crystals was less than the width and height.

Seeding Techniques

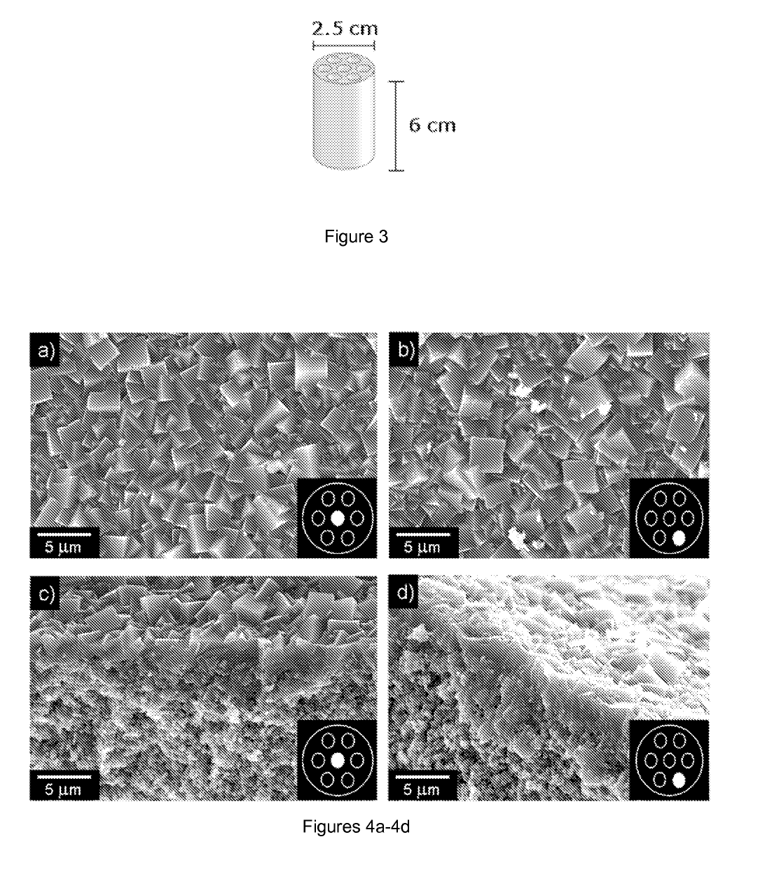

Alumina tubular supports (11-mm OD, 7-mm ID, 100- or 200-nm average pore sizes) and monolith supports (7-channels, 25-mm OD, 6-mm ID, 200-nm average pore size) from Inopor GmbH (Veilsdorf, Germany) were cut into 6-cm long pieces, and the ends were glazed using Duncan ceramic glaze at 1173 K with heating and cooling rates of 1 K/min. The glazed supports were washed four times with boiling DI water for 30 min and dried overnight at 373 K before using them for synthesis. A schematic of the monolith supports is shown in FIG. 3. Three seeding methods were used for membrane synthesis:

Rub-coating: Dry, uncalcined SAPO-34 seeds were rubbed onto the inside surface of the supports with a cotton-tipped swab.

Dip-coating: The dry supports were immersed for about 60 s in ethanol that contained 0.042 wt % SAPO-34 seeds and 0.05 wt % hydroxypropyl cellulose (Sigma Aldrich). The soaked supports were then lifted out of the seed suspension over a 25-s time period, dried at 373 K for 2 h, and calcined in air at 673 K for 4 h.

Seeded synthesis gel: The SAPO-34 seeds were added as aqueous suspensions directly to the aged gel instead of placing them on the support surface. Aqueous seed suspensions were prepared by sonicating 50-200 mg of seeds in 5 g DI water for 1 h.

Membrane Preparation

The SAPO-34 membrane synthesis gel had a molar ratio of 1.0 Al₂O₃:1.0 P₂O₅:0.3 SiO₂:1.0 TEAOH:1.6 dipropylamine (DPA):150 H₂O. All chemicals were purchased from Sigma-Aldrich and used as received. For membranes prepared by dip-coating or rub-coating, 2.37 g H₃PO₄ (85 wt % aqueous solution), 4.30 g Al(i-C₃H₇O)₃ (98%) and 24.30 g DI water were mixed and stirred for 2 h. For seeded-gel synthesis, the quantity of water was reduced to 19.30 g so that the same gel composition would be obtained after the 5 g water in the seed solution was added. Next, for all preparations, 0.46 g Ludox AS-40 colloidal silica gel (40 wt % aqueous solution) was added in the gel and stirred for 0.5 h, and then 4.32 g TEAOH (35 wt % aqueous solution) was added. After the solutions was stirred for 0.5 h, 1.67 g DPA (99%) was added and the resulting gel was aged for 4 days with stirring at 318-323 K. For the seeded gels, the aqueous seed solution was added to the gel and the mixture stirred for 15 min just before the gel was added to the supports. The outer surface of the alumina supports were wrapped tightly with Teflon tape and placed in an autoclave, which was then filled with the synthesis gel. For single-channel membranes, 37 g of synthesis gel was added per membrane; for 7-channel modules, the monolith was placed on a 1-cm stainless steel stand and 25 g of synthesis gel was added per module. Hydrothermal synthesis was carried out in a conventional oven at 483 K for 5-8 h. The membranes were washed with tap water for 15 min and dried at 393 K overnight.

The templates were removed from the membranes under vacuum because it was shown previously that more template was removed in vacuum than in nitrogen or air and permeances were doubled when vacuum was used instead of air (15). A vacuum chamber with a pressure of approximately 0.1 Pa was connected to a quartz tube that contained a membrane, and the quartz tube was placed in a ceramic tubular furnace. The membranes were held at 673 K under vacuum for 4 h with heating and cooling rates of 1 K/min.

Characterization and Separation Measurements

Scanning electron microscopy (SEM) images were obtained with a JEOL JSM-6400 SEM with an acceleration voltage of 25 kV. Carbon dioxide/methane mixtures (50/50) were separated at 295 K in a flow system that has been described previously (4). The feed pressure was between 0.2 and 4.75 MPa, but most measurements were at 4.6 MPa pressure differential. The permeate pressure was 153 kPa, and both feed and permeate pressures were controlled by back pressure regulators. The feed flow rate was controlled by mass flow controllers, up to a maximum total feed flow rate of 24 standard L/min (SLPM). No sweep gas was used. Permeate and retentate flow rates were monitored with bubble flowmeters, and compositions were analyzed by a SRI 8610C GC with a TC detector and a Hayesep D column at 373 K. An automated sample loop obtained samples from both the feed and permeate streams.

The membranes were sealed in a stainless steel module with silicone 0-rings for separations measurements. The leak integrity of the single-channel module was verified by replacing the membrane with a solid stainless steel tube. The leak rate for a 7 MPa pressure drop across the O-ring was ˜0.1% of the measured CH₄ flux for a 50/50 CO₂/CH₄ mixture at the same pressure drop. High feed flow rates were used to minimize concentration polarization (4), along with cylindrical Teflon inserts placed inside each channel to reduce the gas flow cross-section and thus increase the velocity across the membrane surface. The spacers were machined from solid Teflon rods in two parts. The wider end of each part fit tightly into the glazed ends of the channel. A metal pin at the end of one spacer mated with a hole in the other to align the two spacers. Gas entered through an axial opening at the end of the spacer and was distributed through four radially aligned holes. The retentate entered the radial holes on the downstream spacer and exited the membrane through the cylindrical hole in the center of the end of the spacer. Permeances were calculated using log-mean feed concentration as the driving force since because the feed compositions changed significantly along the membrane axis.

Results and Discussion: Single Channel Membrane Synthesis

Ten single-channel SAPO-34 membranes were synthesized by each of the three seeding methods (30 membranes total), and their average, high-pressure separation performance at 4.6 MPa is shown in Table 1. The best single-channel membranes, for seeds deposited by either dip- or rub-coating, were obtained with a synthesis time of 5 h. Longer synthesis times of 7 h were required to obtain selective membranes when the seeds were dispersed in the gel instead of being attached to the support surface. All membranes had permeances greater than 4×10⁻⁷ mol/(m² s Pa) and average selectivities were above 45. The average permeances were 15% higher for membranes prepared using seeded gels than for membranes prepared by rub-coating, and their selectivities were 13% higher. The permeances and selectivities were lowest for the dip-coated membranes.

Of particular significance for large-scale application of these membranes, the standard deviations for both CO₂ permeances and CO₂/CH₄ selectivities were only 10% for membranes prepared with seeded gels, whereas membranes prepared by rub-coating and dip-coating had standard deviations of 18-22% for permeance and 31-34% for selectivity. In addition to improvements in permeance, selectivity, and reproducibility, preparing membranes using seeded gels decreases the number of steps and the time required for membrane preparation. Compared to dip-coated membranes, seeded gel preparation eliminates the dip-coating step and the subsequent calcination that is needed to remove the hydroxypropyl cellulose prior to hydrothermal synthesis. It also eliminates the use of the hydroxypropyl cellulose, but it increases the amount of seeds required for membranes synthesis by about a factor of 120. The seeded gel method is also much easier to scale up than rub-coating.

Monolith Membrane Synthesis

Similar to the single channel membranes, longer synthesis times were required to prepare selective monolith membranes using seeded gels. As shown in Table 2, the monolith membranes were not selective after 5 h synthesis times and the best membranes were obtained after a synthesis time of 7 h. The significantly lower permeance for a membrane prepared with an 8-h synthesis may be due to formation of a thicker SAPO-34 layer. The seed concentration in the gel for the membranes shown in Table 2 was 2.7 mg seeds/g gel since the higher and lower seed concentrations tested did not yield monolith membranes with as good separation performance for the selected membrane synthesis conditions, as shown in Table 3. Membranes synthesized using 1.35 mg of seeds/g of gel and 7-h synthesis time were not selective for CO₂/CH₄ separations at high pressure. Apparently the gases permeated through defects for membranes prepared using this seed concentration, and permeation was dominated by Knudsen diffusion, since CH₄ permeated faster than CO₂. When the seed concentration was doubled to 2.7 mg/g gel, the CO₂/CH₄ selectivity was 54, and the CO₂ permeance was high. When the seed concentration was doubled again, however, the selectivity was much lower. Thus 2.7 mg seeds/g gel were used for all other preparations using seeded gels. A continuous layer may not have formed on the support if the seed concentration was too low, and if the seed concentration was too high, the gel may have been depleted by crystallization in the bulk.

Similar to single channel membranes, monolith membranes prepared by seeding the gel also had higher selectivity and were more reproducible than membranes that were seeded by rub- and dipcoating as shown in Table 4. For this comparison, twelve SAPO-34 membranes were prepared on 7-channel monolith supports using the three seeding methods: five were dip-coated, two were rub-coated, and five were synthesized with a seeded-gel. Only two rub-coated monolith membranes were prepared because it was difficult to reproducibly rub the seeds onto the inner surface of each of the seven smaller diameter (6 mm I.D.) channels. The monolith membranes prepared using seeded gels (seed concentration of 2.7 mg seeds/g gel and synthesis time of 7 h) had the highest average separation selectivity (56) and their average permeance was the same as the dip-coated monoliths. They also had the lowest standard deviations for permeance (14%) and selectivity (7%). Thus, monolith preparation was more reproducible when seeded gels were used. The average permeances and selectivities for monolith membranes synthesized by rub-coating were only 60% and 40%, respectively, of the values for the seeded-gel membranes. Their standard deviations for permeance (38%) and selectivity (57%) were also much larger. The monolith membranes prepared by depositing the seeds by dip-coating were closer to membranes prepared with the seed gel, but their selectivities were lower and their standard deviations in permeance (17%) and selectivity (27%) were significantly higher.

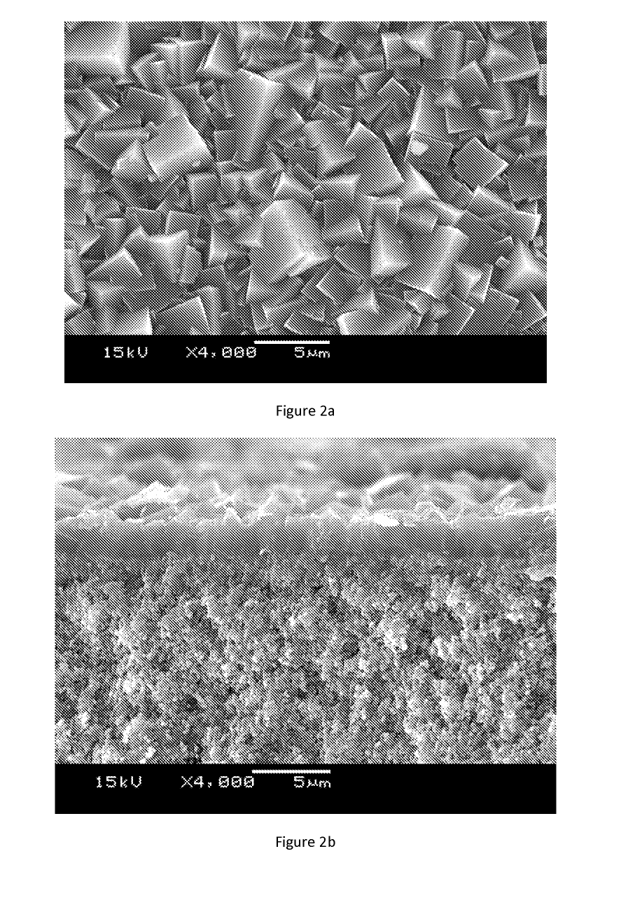

The SAPO-34 layer on the surface of a monolith membrane that was grown using a seeded gel had a morphology (FIGS. 4 a and 4b) that was similar to that obtained previously for single-channel SAPO-34 membranes (FIG. 2a). The SAPO-34 layers are composed of intergrown rectangular crystals, and the layers on the center channel surfaces are similar to those in outer channels. Despite the potential for radial thermal gradients in the monolith during synthesis, the SAPO-34 layer was about 3 μm thick in the outer channels and about 2 μm thick in the center channel (SEM images in (FIGS. 4 c and 4d). In contrast, the SAPO-34 layers in the single-channel membranes were typically about 5 μm thick.

Low Pressure Separations with Monolith Membranes

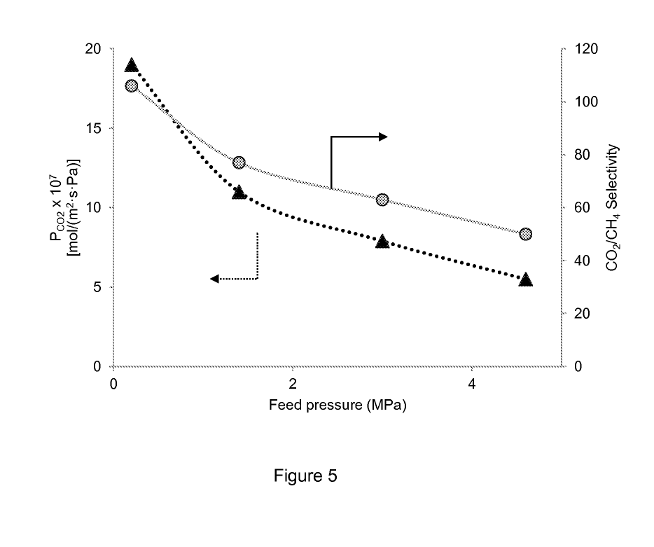

Both CO₂ permeance and CO₂/CH₄ separation selectivity at 295 K decreased for a seeded-gel monolith membrane as the feed pressure increased (FIG. 5). This behavior is similar to that reported previously for single-channel SAPO-34 membranes as a function of pressure (8). Thus, scaling up SAPO-34 membranes to multi-channel monoliths utilizing seeded-gel synthesis yields membranes with separation properties similar to those of single channel SAPO-34 membranes. At a feed pressure of about 0.2 MPa (220 kPa), the CO₂ permeance was 1.9×10⁻⁶ mol/(m² s Pa) and the selectivity was 106. The membrane performance decreased as pressure increased because CO₂ loading approached saturation, CH₄ permeation through defects increased proportionally more than CH₄ permeance through SAPO-34 pores, and concentration polarization increased (4).

Concentration Polarization in Monolith Membranes

The monolith surface areas and fluxes are six times higher than those for the single channel membranes. As a result, at the same feed flow rate, concentration polarization decreases the separation performance more for the monolith because the feed becomes more depleted than in the single channel membranes, and because the flow cross section is approximately six time larger. The gas velocity near the membrane interface decreases with increasing pressure because the gas becomes denser, and the flux through the membrane increases due to a higher driving force. This higher flux further decreases the gas velocity along the membrane. It was reported previously that when the feed pressure increased from 0.2 to 5 MPa for a single-channel membrane, the gas velocity decreased a factor of 20, the total permeate flux almost increased a factor of 20, and the bulk diffusivity of CO₂ in CH₄ decreased by 96% (4). To minimize concentration polarization, feed flow rates were increased and Teflon spacers were inserted into each channel to create an annular cross section for flow that was approximately 0.15-mm wide. This decreased the diffusion distance to 5% of its value for the empty channel and increased the gas velocity by a factor of approximately 10. All the measurements reported above used the Teflon inserts.

Concentration polarization had a dramatic effect on CO₂/CH₄ separations for a monolith membrane at 4.6 MPa, as shown in Table 5. The CO₂ permeance was 2.5 times higher with the Teflon insert, and the CO₂/CH₄ separation selectivity was 3.2 times higher. Concentration polarization may still diminish membrane performance, even with the Teflon insert, because the maximum feed flow rate was limited by the system mass flow meters. Thus, the permeances and selectivities reported in this paper for monolith membranes are lower limits of the intrinsic values. Performance data herein was acquired at a stage-cut (ratio of permeate flow rate to retentate flow rate) between 0.25 and 0.4. The permeance of the alumina supports with a structure similar to that of the monolith was about 3×10⁻⁵ mol/(m²sPa) or less than 3% of the highest permeance measured with the monolith membranes. Support resistance was thus not considered important for the conditions used.

Summary

Monolith supports were used to prepare SAPO-34 zeolite membranes that separated CO₂/CH₄ mixtures at 4.6 MPa pressure, and membrane preparation was reproducible. Monoliths increase the membrane surface area per volume, and thus have the potential to decrease membrane module cost. The best monolith membrane prepared in this study had a permeance of 7.1×10⁻⁷ mol/(m²s Pa) and a separation selectivity of 54 at a pressure differential of 4.6 MPa. Because of the high permeate flow rates through these monoliths, the intrinsic permeances and selectivities are probably higher, but are limited by concentration polarization.

An improved method of membrane preparation, which essentially eliminates one step and therefore potentially reduces cost, preparation time, and preparation complexity, was developed. Instead of placing SAPO-34 seeds on the support surface, SAPO-34 seeds were added to the synthesis gel just before the gel was added to the supports, and the synthesis time was increased slightly to obtain membranes of higher quality and better reproducibility than membranes obtained when the seeds were placed directly on the support by dip-coating or rub-coating.

Also see Ping et al. (Ping et al. J. Membrane Science, 415-416 (2012) 770-775), which is hereby incorporated by reference in its entirety for its description of experimental results relating to the SAPO-34 membranes and synthesis methods.

TABLE 1
Effect of seeding method on high-pressure CO₂/CH₄ separation
performance at 295 K of single-channel SAPO-34 membranes
(ΔP: 4.6 MPa, feed flow rate: 7 standard L/min)

| | CO₂ permeance × | |
|---|---|---|
| Seeding | 10⁷ | CO₂/CH₄ |
| method* | [mol/(m² s Pa)] | selectivity |
| Rub-coating | 5.4 ± 1.2 | 47 ± 16 |
| Dip-coating | 5.0 ± 0.9 | 45 ± 14 |
| Seeded gel** | 6.2 ± 0.6 | 53 ± 5 |

*Ten membranes were prepared by each method,
**2.7 mg seeds/g synthesis gel

TABLE 2
Effect of synthesis time on high-pressure CO₂/CH₄ separation
performance at 295 K of SAPO-34 monolith membranes prepared
using seeded gels with 2.7 mg seeds/g gel (ΔP: 4.6
MPa, feed flow rate: 20 standard L/min)

| | CO₂ permeance × | |
|---|---|---|
| Synthesis | 10⁷ | CO₂/CH₄ |
| time (h) | [mol/(m² s Pa)] | selectivity |
| 5 | >100 | <1 |
| 6 | 6.3 | 47 |
| 7 | 6.9 | 54 |
| 8 | 2.0 | 35 |

TABLE 3
Effect of seed concentration in synthesis gel on high-
pressure CO₂/CH₄ separation performance at 295 K of
SAPO-34 monolith membranes synthesized for 7 h (ΔP:
4.6 MPa, feed flow rate: 20 standard L/min)

| Seed | CO₂ permeance × | |
|---|---|---|
| concentration | 10⁷ | CO₂/CH₄ |
| [mg_{seeds}/g_{gel}] | [mol/(m² s Pa)] | selectivity |
| 1.35 | >100 | <1 |
| 2.7 | 6.9 | 54 |
| 5.4 | 6.6 | 10 |

TABLE 4
Effect of seeding method on high-pressure CO₂/CH₄ separation
performance at 295 K of SAPO-34 monolith membranes (ΔP:
4.6 MPa, feed flow rate: 20 standard L/min)

| | CO₂ permeance × | |
|---|---|---|
| Seeding | 10⁷ | CO₂/CH₄ |
| method | [mol/(m² s Pa)] | selectivity |
| Rub-coating | 3.7 ± 1.4 | 21 ± 12 |
| Dip-coating | 6.3 ± 1.1 | 44 ± 12 |
| Seeded gel | 6.3 ± 0.9 | 56 ± 4 |

TABLE 5
Effect of concentration polarization on high-pressure
CO₂/CH₄ separation performance at 295 K for a SAPO-
34 monolith membrane prepared using seeded gels (ΔP:
4.6 MPa, feed flow rate: 20 standard L/min)

| | CO₂ permeance × | |
|---|---|---|
| Teflon | 10⁷ | CO₂/CH₄ |
| inserts | [mol/(m² s Pa)] | selectivity |
| Yes | 6.9 | 54 |
| No | 2.7 | 17 |

### REFERENCES

(1) R. W. Baker, Future directions of membrane gas separation technology, Ind Eng Chem Res, 41 (2002) 1393.
(2) W. J. Koros, R. Mahajan, Pushing the limits on possibilities for large scale gas separation: which strategies?, J Membrane Sci, 175 (2000) 181.
(3) J. L. Falconer, S. G. Li, M. A. Carreon, Y. F. Zhang, H. H. Funke, R. D. Noble, Scale-up of SAPO-34 membranes for CO₂/CH₄ separation, J Membrane Sci, 352 (2010) 7.
(4) H. H. Funke, A. M. Avila, Y. F. Zhang, J. L. Falconer, R. D. Noble, Concentration polarization in SAPO-34 membranes at high pressures, J Membrane Sci, 335 (2009) 32.
(5) S. G. Li, J. L. Falconer, R. D. Noble, SAPO-34 membranes for CO₂/CH₄ separations: Effect of Si/Al ratio, Micropor Mesopor Mat, 110 (2008) 310.
(6) J. L. Falconer, M. A. Carreon, S. G. Li, R. D. Noble, SAPO-34 seeds and membranes prepared using multiple structure directing agents, Adv Mater, 20 (2008) 729.
(7) J. L. Falconer, M. A. Carreon, S. G. Li, R. D. Noble, Alumina-supported SAPO-34 membranes for CO₂/CH₄ separation, J Am Chem Soc, 130 (2008) 5412.
(8) S. G. Li, J. L. Falconer, R. D. Noble, Improved SAPO-34 membranes for CO₂/CH₄ separations, Adv Mater, 18 (2006) 2601.
(9) J. L. Falconer, S. G. Li, J. G. Martinek, R. D. Noble, T. Q. Gardner, High-pressure CO₂/CH₄ separation using SAPO-34 membranes, Ind Eng Chem Res, 44 (2005) 3220.
(10) J. L. Falconer, S. G. Li, G. Alvarado, R. D. Noble, Effects of impurities on CO₂/CH₄ separations through SAPO-34 membranes, J Membrane Sci, 251 (2005) 59.
(11) J. L. Falconer, S. G. Li, R. D. Noble, SAPO-34 membranes for CO₂/CH₄ separation, J Membrane Sci, 241 (2004) 121.
(12) T. C. Bowen, H. Kalipcilar, J. L. Falconer, R. D. Noble, Pervaporation of organic/water mixtures through B-ZSM-5 zeolite membranes on monolith supports, J Membrane Sci, 215 (2003) 235.
(13) H. Kalipcilar, S. K. Gade, R. D. Noble, J. L. Falconer, Synthesis and separation properties of B-ZSM-5 zeolite membranes on monolith supports, J Membrane Sci, 210 (2002) 113.
(14) H. Kalipcilar, J. L. Falconer, R. D. Noble, Preparation of B-ZSM-5 membranes on a monolith support, J Membrane Sci, 194 (2001) 141-144.
(15) J. L. Falconer, Y. F. Zhang, B. Tokay, H. H. Funke, R. D. Noble, Template removal from SAPO-34 crystals and membranes, J Membrane Sci, 363 (2010) 29-35.
(16) Ping et al. J. Membrane Science, 415-416 (2012) 770-775
(17) Clet et al. Chem. Commun. (2001) 41-42
(18) Clet et al., Chem. Mater. 11 (1999) 1696-1702

1. A method for making a crystalline silicoaluminophosphate-34 (SAPO-34) membrane, the method comprising the steps of:
a) providing a porous support;
b) preparing a SAPO-34 synthesis mixture comprising an aqueous SAPO-34 forming gel and a plurality of SAPO-34 crystals having an average size from 50 nm to 5,000 nm wherein the gel comprises aluminum, phosphorus, silicon, oxygen, and a templating agent, with the ratio of silicon to aluminum being greater than 0.1 and less than or equal to 0.6 and the overall concentration of SAPO-34 crystals in the gel is from 0.5 to 10 mg crystals per gram of gel;
c) contacting at least one surface of the porous support with the synthesis mixture, wherein the average pore size at the surface is less than 5 microns;
d) heating the porous support and the synthesis mixture to a temperature from 450 K to 515K for less than 20 hours to form a continuous layer of SAPO-34 crystals on the surface of the support; and
e) heating the SAPO-34 layer to remove the templating agent.

2. The method of claim 1, wherein the layer of SAPO-34 crystals is washed prior to step e).

3. The method of claim 1, wherein the concentration of SAPO-34 crystals in the synthesis mixture of step b) is from 2.0 to 4.0 mg crystals per gram of synthesis gel.

4. The method of claim 1, wherein the support and gel are heated to a temperature from 470 K to 495 K for 6 to 10 hours.

5. The method of claim 4, wherein the support and gel are heated from a temperature from 480 K to 495 K for 6 to 8 hours.

6. The method of claim 1, wherein the support is a multi-channel monolith.

7. The method of claim 1, wherein the average size of the pores at the surface of the support is less than the average size of the SAPO-34 crystals present in the synthesis mixture of step b).

8. The method of claim 1, wherein the gel is stationary with respect to the support during step d).

9. The method of claim 1, wherein the gel is not stationary with respect to the support during step d).

10. The method of claim 1, wherein the gel composition comprises 1.0 Al₂O₃:aP₂O₅:bSiO₂:cR:eH₂O where R is a quaternary organic ammonium templating agent and
a is greater than 0.5 and less than 1.5,
b is from 0.3 to 0.6,
c is from 0.2 to 5, and
e is from 20 to 300.

11. The method of claim 1, wherein the gel composition comprises 1 Al₂O₃:aP₂O₅:bSiO₂:cR₁:dR₂:eH₂O where R₁ is a quaternary organic ammonium templating agent and R₂ is an amine having a molecular weight (Mn) of less than or equal to 300 and
a is greater than 0.5 and less than 1.5,
b is from 0.3 to 0.6,
c is from 0.2 to 5,
d is greater than 0 and less than 4
e is from 20 to 300.

12. The method of claim 1, wherein the synthesis mixture in step b) is formed by combining an aqueous suspension of the SAPO-34 crystals with an aged aqueous SAPO-34 forming gel, the gel being aged for at least 6 hours at a temperature from 290 K to 350K prior to combination with the aqueous suspension of SAPO-34 crystals.

13. The method of claim 12, wherein the gel is aged at a temperature from 300 K to 350 K.

14. The method of claim 10, wherein the SAPO-34 layer is heated at a temperature from 600 K to 1050 K in an O₂ reduced atmosphere or an O₂ free atmosphere.

15. The method of claim 1, wherein the CO₂/CH₄ separation selectivity of the membrane is greater than 50 and the CO₂ permeance is greater than 5×10⁻⁷ (mol/(m²s Pa)) for an approximately 50/50 CO₂/CH₄ mixture at about 295 K with a pressure differential across the membrane of 4.6 MPa and 153 kPa permeate pressure.

16. A supported membrane made by the methods of claim 1.

17. The membrane of claim 16 wherein the CO₂/CH₄ separation selectivity of the membrane is greater than 50 and the CO₂ permeance is greater than 5×10⁻⁷ (mol/(m²s Pa)) for an approximately 50/50 CO₂/CH₄ mixture at about 295 K with a pressure differential across the membrane of 4.6 MPa and 153 kPa permeate pressure.

18. The membrane of claim 16 wherein the membrane is formed inside a channel of a multichannel monolith.

19. A method for separating a first gas component from a gas mixture including at least a first and a second gas component, the method comprising the steps of:
a) providing a membrane of claim 16, the membrane having a feed and a permeate side and being selectively permeable to the first gas component over the second gas component;
b) applying a feed stream including the first and the second gas components to the feed side of the membrane; and
c) providing a driving force sufficient for permeation of the first gas component through the membrane, thereby producing a permeate stream enriched in the first gas component from the permeate side of the membrane.

20. The method of claim 19 wherein the first gas component is carbon dioxide and the second gas component is methane.
